(19) United States
(12) Patent Application Publication
(10) Pub. No.: US 2025/0286180 A1
(43) Pub. Date: Sep. 11, 2025

(54) SECONDARY BATTERY

(71) Applicant: Samsung SDI Co., Ltd., Yongin-si (KR)

(72) Inventors: Won Chull Han, Yongin-si (KR); Young Ho Kim, Yongin-si (KR)

(73) Assignee: Samsung SDI Co., Ltd., Yongin-si (KR)

(21) Appl. No.: 18/794,872

(22) Filed: Aug. 5, 2024

(30) Foreign Application Priority Data
Mar. 11, 2024 (KR) 10-2024-0033612

(51) Int. Cl. H01M 50/186; H01M 50/107; H01M 50/152; H01M 50/184; H01M 50/198; H01M 50/533; H01M 50/586; H01M 50/59

(52) U.S. Cl. CPC H01M 50/186; H01M 50/107; H01M 50/152; H01M 50/184; H01M 50/198; H01M 50/533; H01M 50/586; H01M 50/59

(57) ABSTRACT

A secondary battery may include a can having one end opened, an electrode assembly accommodated in the can, a cap plate coupled to the one end of the can that is opened, and a gasket surrounding at least a portion of top and bottom surfaces of the cap plate and integrated with the cap plate. According to some embodiments of the present disclosure, the cap plate and the gasket may be integrated with each other to reduce costs and assembly time. In addition, the thickness of the gasket at the lower portion of the cap plate may be reduced to secure the space for improving the battery capacity while maintaining the sealing performance.

### CROSS-REFERENCE TO RELATED APPLICATIONS

This present application claims priority to and the benefit under 35 U.S.C. § 119(a)-(d) of Korean Patent Application No. 10-2024-0033612, filed on Mar. 11, 2024, in the Korean Intellectual Property Office, the entire disclosure of which is incorporated herein by reference.

### FIELD

Embodiments relate to a secondary battery.

### BACKGROUND

A cylindrical secondary battery may include a cylindrical can having one end opened and having a cap plate coupled to said one end that is opened. In general, the cap plate may be insulatingly coupled to a can (e.g., coupled through a gasket or insulator made of insulating material). The gasket can function to insulate the can from the cap plate and seal the can at the same time.

The above-described information disclosed in the technology that serves as the background of the present disclosure is only for improving understanding of the background of the present disclosure and thus may include information that does not constitute the related art.

### SUMMARY

Aspects of some embodiments of the present disclosure provide a secondary battery having an improved structure of a cap assembly.

According to some embodiments, a secondary battery includes: a can having one end opened; an electrode assembly accommodated in the can; a cap plate coupled to the one end of the can; and a gasket configured to surround at least a portion of top and bottom surfaces of the cap plate and integrated with the cap plate.

The can may have a cylindrical shape, and the cap plate may have a circular plate shape.

The gasket may have a ring shape with a predetermined width and include a first portion disposed on the top surface of the cap plate, a third portion disposed on the bottom surface of the cap plate, and a second portion configured to connect the first portion to the third portion.

The cap plate may include a coupling part disposed on an area of the top surface that is in contact with the first portion.

The coupling part may have a sawtooth shape in cross-section.

The coupling part may be disposed in a circumferential direction of the cap plate.

The coupling part may be manufactured through a knurling method.

A height of the coupling part may be within about 30% of a thickness of the cap plate.

The gasket and the cap plate may be provided through double injection.

The gasket may be made of an insulating material.

In the gasket, a thickness of the third portion may be less than that of the first portion.

The cap plate may include a notch disposed along a circumferential direction.

The cap plate may include a first area, a second area disposed inside the first area and provided to be concave in a direction of the electrode assembly, and a third area disposed outside the first area and disposed in the same line as the second area.

The notch may be provided in the first area.

The gasket may be configured to surround the third area and may be spaced apart from the notch.

The gasket may further include an extension portion protruding from an end of the third portion toward the electrode assembly.

The secondary battery may further include a first current collector plate electrically connected to a positive electrode plate of the electrode assembly; and a second current collector plate electrically connected to a negative electrode plate of the electrode assembly, wherein the extension portion may have a length at which the extension portion is not in contact with the second current collector plate.

The can may include a circular top surface part and a side part extending downward from the top surface part, and the second current collector plate may include a plurality of negative electrode leads electrically connected to the side part.

The can may further include: a beading part provided to be concave inward from the side part; and a crimping part spaced apart from the beading part and provided by bending an end of the side part inward, wherein a negative electrode lead of the plurality of negative electrode leads may be inserted between the beading part and the second gasket.

The secondary battery may further include: a positive electrode terminal inserted into the top surface part and electrically connected to the first current collector plate; and a gasket disposed between the top surface part and the positive electrode terminal and made of an insulating material.

### BRIEF DESCRIPTION OF THE DRAWINGS

FIG. 1 illustrates a perspective view of a secondary battery, according to some embodiments;

FIG. 2 illustrates a cross-sectional view of the secondary battery of FIG. 1;

FIG. 3 illustrates a partial perspective view of an arrangement of a cap assembly and an electrode assembly of the secondary battery of FIG. 2;

FIG. 4 illustrates a front view of a portion of the cap assembly and a portion of the electrode assembly of the secondary battery of FIG. 2;

FIG. 5 illustrates a perspective view of the cap assembly of the secondary battery of FIG. 2;

FIG. 6 illustrates a rear perspective view of the cap assembly of the secondary battery of FIG. 2;

FIG. 7A illustrates a partial cross-sectional view of a portion of the cap assembly, taken along line A-A in FIG. 5; and

FIGS. 7B illustrates a partial cross-sectional view of the cap assembly of FIG. 7A, according to other embodiments.

### DETAILED DESCRIPTION

The present disclosure may be embodied in many different forms and should not be construed as being limited to the embodiments set forth herein; rather, these embodiments are provided so that those skilled in the art thoroughly understand the present disclosure. Further, these embodiments are provided so that this disclosure will be thorough and complete, and will fully convey the scope of the present disclosure to those skilled in the art.

In addition, in the accompanying drawings, the thickness or size of each layer is exaggerated for simplicity and clarity of description, and the same reference numerals in the drawings refer to the same elements. As used herein, the term “and/or” includes any and all combinations of one or more of the associated listed items. In this specification, it will also be understood that if a member A is referred to as being connected to a member B, the member A may be directly connected to the member B or indirectly connected to the member B with a member B therebetween.

The terms used herein are for illustrative purposes of the present disclosure only and should not be construed to limit the meaning or the scope of the present disclosure. As used in this specification, a singular form may, unless definitely indicating a particular case in terms of the context, include a plural form. Also, the expressions “comprise/include” and/or “comprising/including” used in this specification specify the presence of but neither define the mentioned shapes, numbers, steps, operations, members, elements, and/or groups of these, nor exclude the presence or addition of one or more other different shapes, numbers, steps, operations, members, elements, and/or groups of these, or addition of these. The term “and/or” used herein includes any and all combinations of one or more of the associated listed items.

As used herein, terms such as “first,” “second,” etc. are used to describe various members, components, areas, layers, and/or portions. However, it is obvious that the members, components, areas, layers, and/or portions should not be defined by these terms. The terms do not mean a particular order, up and down, or superiority, and are used only for distinguishing one member, component, region, layer, or portion from another member, component, region, layer, or portion. Thus, a first member, component, region, layer, or portion which will be described may also refer to a second member, component, region, layer, or portion, without departing from the teaching of the present disclosure.

Spatially relative terms, such as “below”, “beneath”, “lower”, “above”, “upper” and the like, may be used herein for ease of description to describe one element or feature's relationship to another element(s) or feature(s) as shown in the figures. These spatially relative terms are intended for ease of comprehension of the present disclosure according to various process states or usage states of the present disclosure, and thus, the present disclosure is not limited thereto. For example, if an element or feature shown in the drawings is turned inside out, the element or feature described as “beneath” or “below” may change into “above” or “upper”. Thus, the term “lower” may encompass the term “upper” or “below”.

The term “about” may be used to mean within ±20% of a target value in some embodiments, within ±10% of a target value in some embodiments, and within ±5% of a target value in some embodiments. The term “about” may equal the target value.

Hereinafter, a secondary battery, according to some embodiments of the present disclosure, will be described in detail with reference to the accompanying drawings.

As described herein, a cylindrical secondary battery may include a cylindrical can having one end opened and having a cap plate coupled to said end. In general, the cap plate may be coupled through a gasket or insulator made of insulating material. The gasket can function to insulate the can from the cap plate and seal the can.

As a thickness of the gasket increases, sealing performance is improved, but as the thickness of the gasket increases, a size of the electrode assembly has to be reduced, which reduces a capacity of the secondary battery. Thus, it is desirable to provide a structure that is capable of increasing the capacity of the secondary battery while maintaining the sealing function.

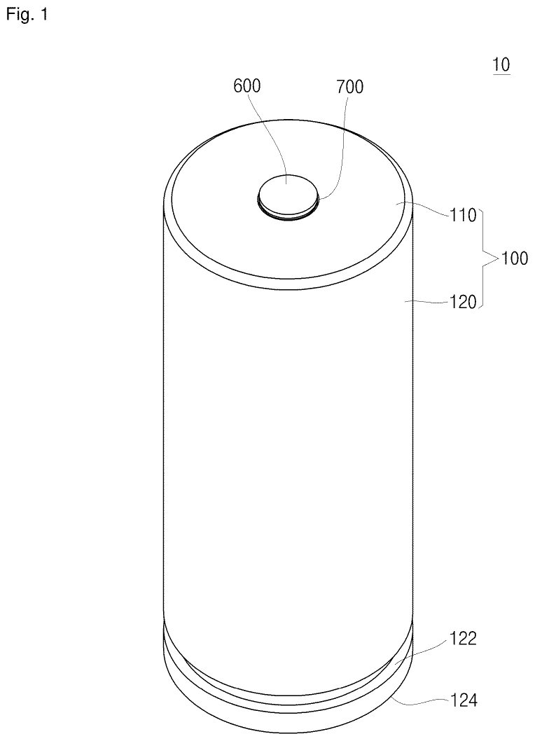

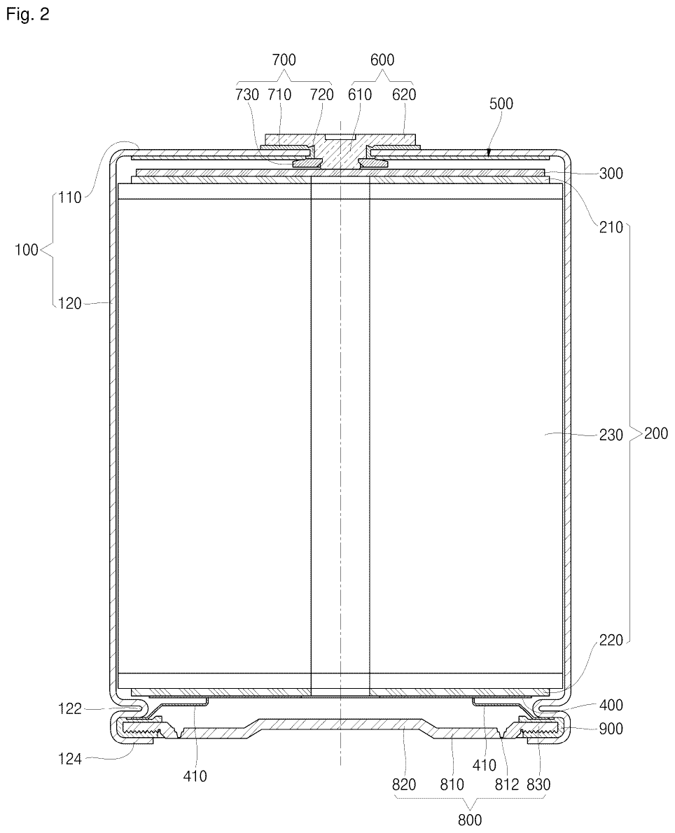

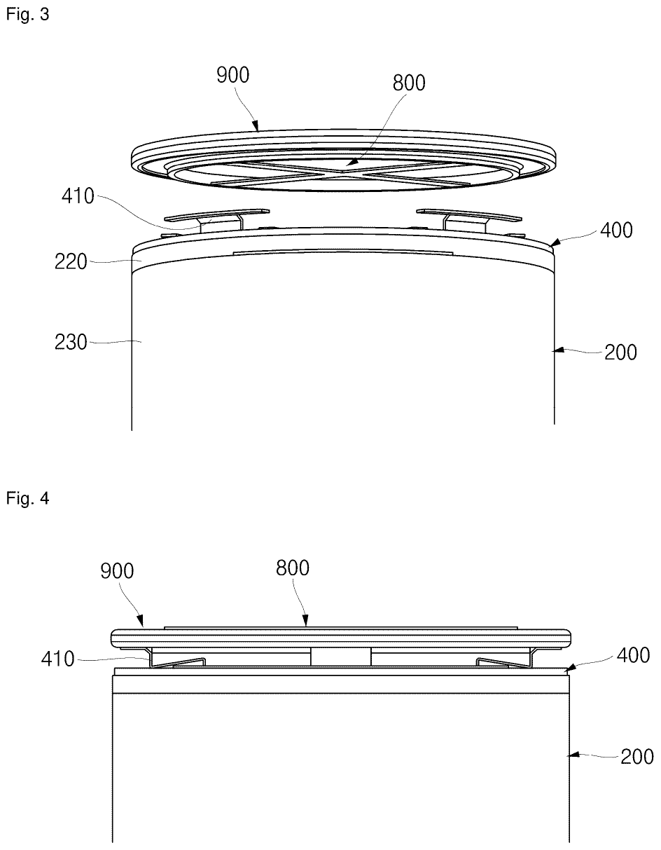

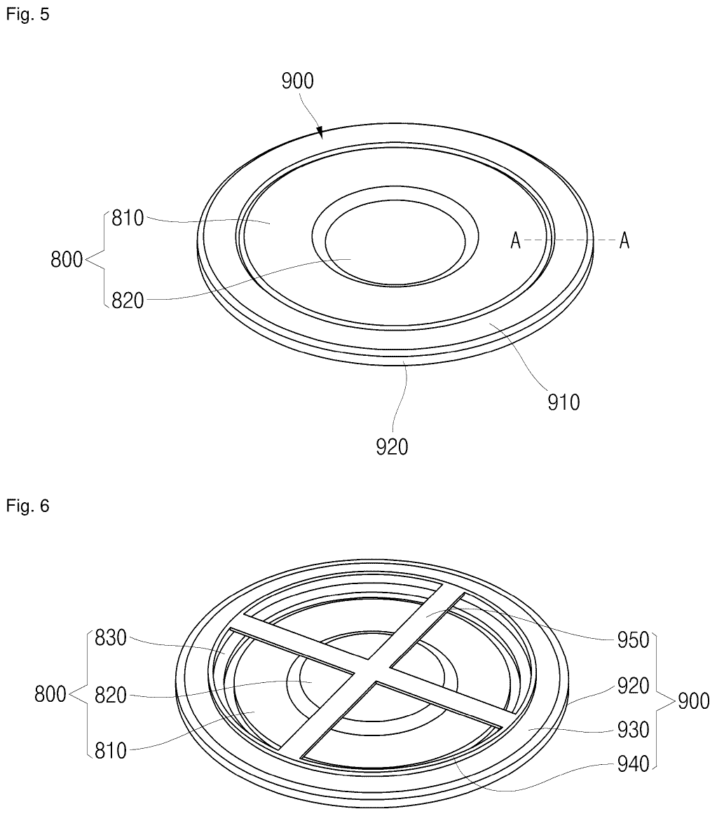

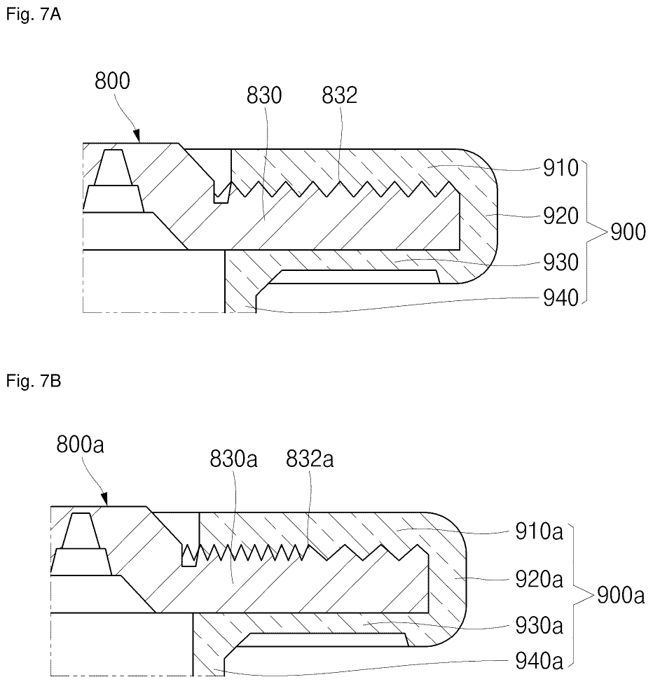

FIG. 1 illustrates a perspective view of a secondary battery, according to some embodiments. FIG. 2 illustrates a cross-sectional view of the secondary battery of FIG. 1. FIG. 3 illustrates a partial perspective view of an arrangement of a cap assembly and an electrode assembly of the secondary battery of FIG. 2. FIG. 4 illustrates a front view of a portion of the cap assembly and a portion of the electrode assembly of the secondary battery of FIG. 2. FIG. 5 illustrates a perspective view of the cap assembly of the secondary battery of FIG. 2. FIG. 6 illustrates a rear perspective view of the cap assembly of the secondary battery of FIG. 2. FIG. 7A illustrates a partial cross-sectional view of a portion of the cap assembly, taken along line A-A in FIG. 5.

Referring to FIG. 1, a secondary battery, according to embodiments, may be a cylindrical battery having a cylindrical outer appearance.

Referring to FIGS. 1 to 4, a secondary battery 10, according to some embodiments, may include cap assemblies (e.g., including cap plate 800 and/or second gasket 900). The secondary battery 10 includes a can 100, an electrode assembly 200, a first current collector plate 300, a second current collector plate 400, an insulating member 500, a positive electrode terminal 600, a first gasket 700, a cap plate 800, and a second gasket 900.

Referring to FIGS. 1 and 2, the can 100 may accommodate the electrode assembly 200 and an electrolyte and may have a substantially cylindrical shape. The can 100 may include a circular top surface part 110 and a side part 120 extending downward from the top surface part 110. The positive electrode terminal 600 and the first gasket 700 may be coupled to the top surface part 110. In some embodiments, a terminal hole (not shown in FIG. 1) may be defined to pass through a center of the top surface 110. A beading part 122 and a crimping part 124 may be provided at a lower portion of the side part 120. In some embodiments, an example secondary battery in which a lower portion of the can 100 is opened is described, but conversely, an upper portion of the can 100 may be opened.

In some embodiments, when assembling the electrode assembly 200 into the can 100, the top surface part 110 may be disposed downward, the electrode assembly 200 may be inserted, and the beading part 122 may be provided. The beading part 122 may prevent the electrode assembly 200 from being separated. The beading part 122 may be provided by processing a lower end of the side part 120 so as to be concave toward the inside of the can 100 (e.g., the beading part may be provided to be concave inward from the side part 120). After providing the beading part 122, the cap plate 800 and the second gasket 900 may be assembled, and the crimping part 124 may be provided to prevent the cap plate 800 from being separated. The crimping part 124 may be spaced apart from the beading part and may be provided by bending an end of the side part 120 toward the inside of the can 100.

Referring to FIGS. 2 to 4, the electrode assembly 200 may include a first electrode plate 210, a second electrode plate 220, and a separator 230.

The first electrode plate 210 may be any one of a negative electrode plate and a positive electrode plate. In some embodiments, the description will be based on an example in which the first electrode plate 210 is a positive electrode plate. The first electrode plate 210, which may be the positive electrode plate, may be provided as a thin metal plate having excellent conductivity, for example, aluminum (Al) foil or mesh. The first electrode plate 210 may be provided with a positive electrode coated portion coated with a positive electrode active material and a positive electrode non-coated portion that is not coated with the positive electrode active material. For example, the positive electrode active material may be formed of a chalcogenide compound, for example, composite metal oxide such as LiCoO₂, LiMn₂O₄, LiNiO₂, LiNiMnO₂, and the like.

The second electrode plate 220 may be the other of the negative electrode plate and the positive electrode plate. In some embodiments, the description will be based on an example in which the second electrode plate 220 is a negative electrode plate. The second electrode plate 220, which may be the negative electrode plate, may be provided as a conductive metal thin plate, for example, copper (Cu) or nickel (Ni) foil or mesh. The second electrode plate 220 may be provided with a negative electrode coated portion coated with a negative electrode active material and a negative electrode non-coated portion that is not coated with the negative electrode active material. For example, the negative electrode active material may include a carbon-based material, silicon (Si), tin (Sn), tin oxide, a tin alloy composite, transition metal oxide, lithium metal nitrite, or metal oxide.

The separator 230 may be interposed between the first electrode plate 210 and the second electrode plate 220 such as to serve to prevent short circuit between the first electrode plate 210 and the second electrode plate 220. In some embodiments, the separator 230 may be made of polyethylene, polypropylene, a porous copolymer of polyethylene and polypropylene, or the like.

For example, the electrode assembly 200 may be disposed so that the non-coating portion of the first electrode plate 210 protrudes upward from an upper end of the second electrode plate 220. In some embodiments, the non-coating portion of the second electrode plate 220 may be disposed to protrude downward from a lower end of the first electrode plate 210 and may be wound in a jelly-roll shape. In this state, the first current collector plate 300 may be welded to the non-coating portion of the first electrode plate 210, and the second current collector plate 400 may be welded to the non-coating portion of the second electrode plate 220.

Referring to FIG. 2, the first current collector plate 300 may be disposed between the top surface part 110 and the non-coated portion of the first electrode plate 210. The first current collector plate 300 may be welded and electrically connected to the first electrode plate 210, which may be the positive electrode plate, and thus may be defined as a positive current collector plate. The first current collector plate 300 may have an approximately circular plate shape. The first current collector plate 300 may be electrically connected to the positive electrode terminal 600 at a central portion thereof. However, the first current collector plate 300 has to be insulated from the can 100. In some embodiments, the insulating member 500, which will be described later, may be provided between the first current collector plate 300 and the can 100.

Referring to FIGS. 2 to 4, the second current collector plate 400 may be disposed between the cap plate 800 and the non-coated portion of the second electrode plate 220. The second current collector plate 400 may be welded and electrically connected to the second electrode plate 220, which may be the negative electrode plate, and thus may be defined as a negative electrode current collector plate. The second current collector plate 400 may have an approximately circular plate shape. A plurality of negative electrode leads 410 may protrude from the second current collector plate 400 (e.g., the second current collector plate may include a plurality of leads). The second current collector plate 400 may be electrically connected to the side part 120 of the can 100 through the negative electrode leads 410 (e.g., the negative electrode leads electrically connected to the side part).

Each of the negative electrode leads 410 may be in the form of a plate having a predetermined length and width. The negative electrode lead 410 may be in contact with the beading part 122 to be welded. The negative electrode lead 410 may be fixed by the beading part 122, the second gasket 900, and the crimping part 124, which will be described later, without welding. The negative electrode lead may be inserted between the beading part and the second gasket. Therefore, the welding between the negative electrode lead 410 and the beading part 122 may be omitted. In some embodiments, the second current collector plate 400 may be directly welded to the side part 120 and electrically connected without the negative electrode lead 410. Because the negative electrode lead 410 is electrically connected to the side part 120, the can 100 may have a negative polarity. Therefore, the positive electrode terminal 600 may be installed to be insulated from the can 100.

The insulating member 500 may have a hollow circular plate shape and may be made of an insulating material. The insulating member 500 may be an insulating tape or an insulating plate. A lower portion of the positive electrode terminal 600 and the first current collector plate 300 may be in contact with and electrically connected through the hollow (e.g., hole) of the insulating member 500. The insulating member 500 may be disposed to be in close contact with the inside of the top surface part 110. In some embodiments, the insulating member 500 may have a size less than or equal to that of the top surface part 110. In some embodiments, the insulating member 500 may be disposed to be in close contact with the top surface of the first current collector plate 300. In some embodiments, the insulating member 500 may have a shape greater than or equal to that of the first current collector plate 300.

Referring to FIGS. 1 and 2, the positive electrode terminal 600 may be a rivet terminal fixed to the top surface part 110 in a rivet manner at the inside or outside. The positive electrode terminal may be inserted into the top surface part. The positive electrode terminal 600 may be installed to be insulated from the top surface 110 of the can 100 by the first gasket 700 (e.g., made of an insulating material) that may be disposed therebetween. The positive electrode terminal 600 may include a substantially cylindrical main body 610 and a head 620 provided by modifying a portion of the main body 610. A lower end of the main body 610 may be disposed inside the top surface part 110. The lower end of the main body 610 may be in contact with and electrically connected to the first current collector plate 300. The head 620 may be deformed if riveted and disposed outside the top surface part 110. The head 620 may be disposed substantially parallel to the top surface part 110 with the first gasket 700 therebetween.

Referring to FIGS. 1 and 2, the first gasket 700 may insulate the positive electrode terminal 600 and the can 100 from each other. In some embodiments, the first gasket 700 may be constituted by an upper gasket 710, an intermediate gasket 720, and a lower gasket 730. The upper gasket 710 may be disposed between the positive electrode terminal 600 and an outer surface of the top surface part 110. The intermediate gasket 720 may be disposed between the terminal hole of the top surface part 110 and the main body 610 of the positive electrode terminal 600. The lower gasket 730 may be disposed between the positive electrode terminal 600 and the insulating member 500. A hollow (e.g., hole) may be defined in the upper gasket 710, the intermediate gasket 720, and the lower gasket 730 to allow the positive electrode terminal 600 to be inserted through the hollow (e.g., hole). In some embodiments, the upper gasket 710, the intermediate gasket 720, and the lower gasket 730 may be integrated with each other. The above-described cap assemblies (e.g., including cap plate 800 and second gasket 900) may be disposed at a side opposite to the positive electrode terminal 600.

Referring to FIGS. 2 to 7A, each of the cap assemblies may include a cap plate 800 and/or a second gasket 900.

Referring to FIGS. 2, 5, and 6, the cap plate 800 may be a circular plate if viewed on a plane. The cap plate 800 may be made of the same material as the can 100 (e.g., steel, nickel-plated steel, steel alloy, aluminum, aluminum alloy, or cold sheet for deep drawing (SPCE), or a laminated film or plastic material that can constitute a pouch). The cap plate 800 may be coupled to the side part 120 by using the second gasket 900 as a medium.

A portion of the cap plate 800 may have a convex shape toward an opposite direction of the electrode assembly 200 (downward direction in FIG. 2). In some embodiments, a portion of the cap plate 800 may have a concave shape in a direction toward the electrode assembly 200 (upward direction in FIG. 2).

With reference to FIG. 2, the convex portion in the downward direction may be defined as a first area 810, and the concave portion in the upward direction may be defined as a second area 820. The second area 820 may be integrated with the outside of the first area 810. The second area may be disposed inside the first area. The first area 810 and the second area 820 may have a height difference therebetween. With reference to FIG. 2, the first area 810 may protrude outward from the second area 820. A notch 812 that functions as a vent may be provided on the first area 810 (e.g., the cap plate may include a notch disposed along a circumferential direction). Alternatively or additionally, a notch may be provided on the second area 820. In some embodiments, a third area 830 may be provided to be integrated with the outside of the first area 810. The third area 830 may be parallel to the second area 820. That is, the third area may be arranged on the same straight line as the second area 820 with respect to FIG. 2. As shown in FIG. 7A, a coupling part 832 having a sawtooth shape in cross section (disposed) in a circumferential direction may be provided on the top surface of the third area 830. The coupling part 832 may be manufactured through a knurling method (the coupling part will be described later). At least a portion of the third area 830 may be disposed between the beading part 122 and the crimping part 124 by using the second gasket 900 as a medium. Because the second gasket 900 (e.g., made of an insulating material) is disposed between the cap plate 800 and the side part 120, the cap plate 800 may be insulated from the can 100. In some embodiments, the cap plate 800 may become neutral (non-polar) having no negative or positive polarity. The third area 830 may be integrated with the second gasket 900 (this will be described later).

The notch 812 may be disposed adjacent to the third area 830. The notch 812 may have a V-shaped cross section as a substantially circular ring-shaped groove. If viewed on the plane, the notch 812 may be provided as a circular groove in the cap plate 800. The notch 812 may serve as a safety vent that is broken if a pressure inside the secondary battery 10 exceeds a certain level (e.g., a set pressure) to allow an internal gas to leak therefrom.

Referring to FIGS. 2 to 7A, the second gasket 900 may have a shape that surrounds a portion of the cap plate 800. The second gasket 900 may be integrated with the cap plate 800 by double injection (e.g., the gasket and cap plate may be provided through double injection). The second gasket 900 may be shaped to surround both upper and lower edges of the cap plate 800 (e.g., based on FIG. 3). In more detail, an area surrounded by the second gasket 900 may be the third area 830 of the cap plate 800 (e.g., the gasket may be spaced apart from the notch). The second gasket 900 may be provided to surround the first area 810, but it may be provided so as not to cover at least the notch 812. In some embodiments, the second gasket 900 may have a ring shape (e.g., a substantially circular ring shape) as illustrated in FIG. 5 if viewed from above, and the second gasket may have a predetermined width. Referring to FIGS. 5 to 7A, the second gasket 900 may include a first portion 910 disposed on a top surface of the third area 830 of the cap plate 800, a second portion 920 disposed on a side surface of the third area 830, a third portion 930 disposed on a bottom surface of the third area 830, an extension portion 940 extending from the third portion 930 toward the electrode assembly 200, and a fourth portion 950 disposed to be across the extension portion 940. The first portion 910, the second portion 920, the third portion 930, the extension portion 940, and the fourth portion 950 may be integrated with each other.

Referring to FIG. 7A, the first portion 910 may have a width corresponding to a horizontal width of the third area 830. The above-described coupling part 832 may be disposed on the third area 830 (e.g., an area of the top surface that is in contact with the first portion). The coupling part 832 may have a sawtooth-shape in cross-section to increase in adhesion (e.g., enhance adhesion) with the second gasket 900 during the double injection. The sawtooth shape of the coupling part 832 may be uniformly disposed with the same size. Because the first portion 910 may be provided to be integrated with the cap plate 800, the first portion 910 may also have a sawtooth-shape in cross-section corresponding to the shape of the coupling part 832 (e.g., the second gasket may be integrated with the cap plate via the coupling part). In some embodiments, the coupling part 832 may be provided in a shape other than the sawtooth shape. In some embodiments, the first portion 910 may also have a cross-sectional shape corresponding to the shape of the coupling part 832.

The second portion 920 may correspond to a side surface of the second gasket 900 to connect the first portion 910 to the third portion 930.

The third portion 930 may be connected to the second portion 920 and may be disposed on the bottom surface of the third area 830 of the cap plate 800. A thickness of a portion of the third portion 930 may be less than that of the other portions (e.g., the first portion) to reduce the thickness.

The extension portion 940 may be a portion that protrudes from an end of the third portion 930 in a direction toward the electrode assembly 200. The extension portion 940 may have a length that is not in contact with the second current collector (e.g., as shown in FIG. 2). The extension portion 940 may allow the sealing force to be maintained even if the thickness of the third portion 930 is reduced.

The fourth portion 950 may have a bar shape having a predetermined width and may be a portion that connects one side of the extension portion 940 to the other side. The fourth portion 950 may be provided in a plurality. The reason why, in some embodiments, the fourth portion 950 does not cover the entire lower portion of the second gasket 900 is to reduce the thickness of the part at the bottom/lower portion of the cap plate 800. In some embodiments, the fourth portion 950 may be disposed in an X or + (plus) shape if viewed from above. The exemplary cross-shaped part may be structured to prevent interference with the current collector.

FIG. 7B illustrates a partial cross-sectional view of the cap assembly of FIG. 7A, according to other embodiments.

Referring to FIG. 7B, in a cap plate 800a according to other embodiments, a coupling part 832a of a third area 830a may have a different sawtooth-shaped density. In some embodiments, a partial area of the coupling part 832a facing a center of the cap plate 800a may have a tooth-shaped density greater than that of an area of the coupling part 832a facing the outside of the cap plate 800a. In some embodiments, a shape of the first portion 910a of a second gasket 900a (e.g., a gasket including second portion 920a, third portion 930a, and extension portion 940a) may also have a shape corresponding to a cross-sectional shape of the coupling part 832a.

In the embodiments of FIGS. 7A and 7B described above, if a thickness (height) of each of the third areas 830 and 830a of the cap plates 800 and 800a is about 1 T (1 mm), a height (thickness) of the sawtooth shape of each of the coupling parts 832 and 832a may be about 0.3 T (0.3 mm). The height of each of the coupling parts 832 and 832a may be changed and/or selected to be within about 30% of the thickness of each of the third areas 830 and 830a of the cap plates 800 and 800a.

As described above, the shape of the second gasket may be changed to reduce the thickness at the lower portion of the cap plate, thereby reducing a total thickness of the cap plate and the second gasket. Therefore, the size of the electrode assembly may increase as the thickness of the second gasket is reduced. In some embodiments, the capacity of the secondary battery may increase.

According to embodiments of the present disclosure, the cap plate and the gasket may be integrated with each other to reduce the costs and the assembly time.

In addition, the thickness of the gasket at the lower portion of the cap plate may be reduced to secure the space for improving the battery capacity while maintaining the sealing performance.

According to some embodiments, there is provided a method of manufacturing a secondary battery such as according to the above-mentioned embodiments, the method including: providing a can having one end opened; accommodating an electrode assembly in the can; coupling a cap plate to the one end of the can that is opened; and integrating a gasket with the cap plate, wherein the gasket is surrounding at least a portion of top and bottom surfaces of the cap plate.

The above-mentioned embodiments are merely exemplary embodiments, and thus, the present disclosure is not limited to the foregoing embodiments. Also, it will be understood by those of ordinary skill in the art that various changes in form and details may be made therein without departing from the spirit and scope of the present disclosure as defined by the following claims.

What is claimed is:

1. A secondary battery comprising:
a can having one end opened;
an electrode assembly accommodated in the can;
a cap plate coupled to the one end of the can; and
a gasket surrounding at least a portion of a top surface and a bottom surface of the cap plate and integrated with the cap plate.

2. The secondary battery as claimed in claim 1, wherein the can has a cylindrical shape, and the cap plate has a circular plate shape.

3. The secondary battery as claimed in claim 2, wherein the gasket has a ring shape with a predetermined width and comprises a first portion disposed on the top surface of the cap plate, a third portion disposed on the bottom surface of the cap plate, and a second portion connecting the first portion to the third portion.

4. The secondary battery as claimed in claim 3, wherein the cap plate comprises a coupling part disposed on an area of the top surface that is in contact with the first portion.

5. The secondary battery as claimed in claim 4, wherein the coupling part has a sawtooth shape in cross-section.

6. The secondary battery as claimed in claim 5, wherein the coupling part is disposed in a circumferential direction of the cap plate.

7. The secondary battery as claimed in claim 6, wherein the coupling part is manufactured through a knurling method.

8. The secondary battery as claimed in claim 7, wherein a height of the coupling part is within about 30% of a thickness of the cap plate.

9. The secondary battery as claimed in claim 7, wherein the gasket and the cap plate are provided through double injection.

10. The secondary battery as claimed in claim 9, wherein the gasket is made of an insulating material.

11. The secondary battery as claimed in claim 10, wherein, in the gasket, a thickness of the third portion is less than that of the first portion.

12. The secondary battery as claimed in claim 4, wherein the cap plate comprises a notch disposed along a circumferential direction.

13. The secondary battery as claimed in claim 12, wherein the cap plate comprises a first area, a second area disposed inside the first area and provided to be concave in a direction of the electrode assembly, and a third area disposed outside the first area and disposed in the same line as the second area.

14. The secondary battery as claimed in claim 13, wherein the notch is provided in the first area.

15. The secondary battery as claimed in claim 14, wherein the gasket is surrounding the third area and is spaced apart from the notch.

16. The secondary battery as claimed in claim 15, wherein the gasket further comprises an extension portion protruding from an end of the third portion toward the electrode assembly.

17. The secondary battery as claimed in claim 16, further comprising a first current collector plate electrically connected to a positive electrode plate of the electrode assembly; and
a second current collector plate electrically connected to a negative electrode plate of the electrode assembly,
wherein the extension portion has a length at which the extension portion is not in contact with the second current collector plate.

18. The secondary battery as claimed in claim 17, wherein the can comprises a circular top surface part and a side part extending downward from the top surface part, and
the second current collector plate comprises a plurality of negative electrode leads electrically connected to the side part.

19. The secondary battery as claimed in claim 18, wherein the can further comprises:
a beading part provided to be concave inward from the side part; and
a crimping part spaced apart from the beading part and provided by bending an end of the side part inward,
wherein a negative electrode lead of the plurality of negative electrode leads is inserted between the beading part and the second gasket.

20. The secondary battery as claimed in claim 18, further comprising:
a positive electrode terminal inserted into the top surface part and electrically connected to the first current collector plate; and
a gasket disposed between the top surface part and the positive electrode terminal and made of an insulating material.
